(19) United States
(12) Patent Application Publication
(10) Pub. No.: US 2016/0140294 A1
(43) Pub. Date: May 19, 2016

(54) SYSTEMS AND METHODS OF PRESENTING DISCRETE PRESCRIPTION DRUG INFORMATION

(71) Applicant: Mobile Health Engagement Strategies, LLC, Roswell, GA (US)

(72) Inventors: Shae McBride, Marietta, GA (US); Kurt Janson, Oakland Township, MI (US)

(21) Appl. No.: 14/540,962

(22) Filed: Nov. 13, 2014

(51) Int. Cl. G06F 19/00

(52) U.S. Cl. CPC G06F 19/322; G06F 19/326

(57) ABSTRACT

A system and method is disclosed for receiving information about a particular drug, subdividing the information into one or more subgroups based on the format of the information, associating a link with each particular subgroup and associating one or more questions with each particular subgroup of information. The system then presents each link to an end user over a mobile computing device that allows the user to select to view one or more of the subgroups of information. Upon receiving a request to view one of the subgroups of information, the system presents the subgroup of information and the questions to the end-user. The system then receives answers to the one or more questions, which subgroups of information that user viewed and the time spend reviewing the information. The system stores the various tracked information and uses the information to improve the information presented to the end-user.

### BACKGROUND

The federal regulation of the healthcare system creates several barriers related to the type of information prescription drug manufacturers can present to doctors. How drug manufacturers can present information, other various compliance requirements, and evolving federal and state physician reporting requirements further complicate manufacturers' efforts. Often, prescription drug manufacturers have sales representatives with limited or non-existent access to physicians. Consumer engagement is similarly complicated, as many consumers find themselves overwhelmed by the number of content sources (e.g. web, apps, live, and print), as well as having trouble ascertaining the validity of the information. For the foregoing considerations and others, drug manufacturers and other vested stakeholders find it extremely difficult to present important information related to drugs and treatments in the context of FDA approved clinical application and utility. Accordingly, there is a need for an improved systems and methods of presenting vital prescription drug information to doctors, patients, and others.

Various embodiments of the present systems and methods recognize and address the foregoing considerations, and others, of prior art systems and methods.

### SUMMARY OF THE VARIOUS EMBODIMENTS

In various embodiments, a computer-implemented method of presenting discrete prescription drug information to a medical professional over a handheld device comprises receiving information associated with a prescription drug. In response to receiving the associated information, the system divides the information into one or more subgroups of information and associates a link with each respective subgroup of information. The system is further configured to associate a plurality of questions with each respective subgroup of information. The system is further configured to present each link to a user, wherein the links are configured to be presented over a mobile device. At least partially in response to receiving a request from a user to view one of the one or more subgroups of information, the system is further configured to present the one of the one or more subgroups of information and the respective plurality of questions to the user. The system is further configured to receive an answer to each one of the plurality of questions, and to track and store: (1) the one or more of the answers received to the plurality of questions; (2) which of the one or more subgroups of information the user viewed; and (3) the time spent by the user in the presented one of the one or more subgroups of information.

In various embodiments, a computer-implemented method of ensuring compliance with standards of treatment among healthcare providers comprises receiving from a first user a standard of care for a first ailment. The system is further configured to present a plurality of questions that relate to the first ailment, and receive an answer to each of the plurality of questions from at least a second user. The system analyzes the received answers to each of the plurality of questions, and compares the analyzed answers to the received standard of care for the first ailment. The system is further configured to determine deviations between the analyzed answers and the received standards of care.

In various embodiments, a computer-implemented method of providing information to a user comprises: (1) receiving one or more medical codes associated with a patient, wherein each one of the one or more medical codes correspond to at least one of a medical condition and medical treatment; (2) analyzing the received one or more medical codes; (3) determining the one of the medical condition and medical treatment associated with each one of the one or more medical codes; and (4) facilitating the delivery of information associated with the one of the medical condition and the medical treatment to the patient.

### BRIEF DESCRIPTION OF THE DRAWINGS

Various embodiments of systems and methods for presenting discrete prescription drug information to a medical professional over a handheld device are described below. In the course of this description, reference will be made to the accompanying drawings, which are not necessarily drawn to scale and wherein:

FIG. 1 is a block diagram of an exemplary system for presenting discrete prescription drug information to a medical professional over a handheld device in accordance with an embodiment of the present system;

FIG. 2 is a block diagram of an information server that may be used in the system shown in FIG. 1;

FIG. 3A depicts a flowchart that generally illustrates a method for presenting discrete prescription drug information over a handheld device;

FIG. 3B depicts a flowchart that generally illustrates a method for presenting and comparing a user's diagnosis and a treatment defined standard of care;

FIG. 3C depicts a flowchart that generally illustrates a method for receiving and analyzing medical codes associated with a patient's medical condition and treatment; and

FIGS. 4A-4G are exemplary screen displays for accessing and utilizing discrete prescription drug information over a handheld device.

### DETAILED DESCRIPTION OF SOME EMBODIMENTS

Various embodiments will now be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A system and method of presenting information related to prescription and other drugs, and related treatment options is disclosed. The system and methods are configured to present information related to prescription and other drugs, treatment options, etc. in a discrete manner to allow doctors and others to review small, pertinent amounts of information quickly. Further the system enables healthcare provider groups to capture analytics related to how doctors in their healthcare provider group intend to administer particular drugs and/or treatments given a clinical scenario, as well as the results of the administration of those drugs and/or treatments as observed by the doctors. In still other embodiments, the system is configured to provide patients and caregivers with pertinent information related to their disease/disorder and treatment methods, such as discharge and post-operative care instructions, motivation and adherence instructions, drug information such as adverse effect warnings, etc. The information may be delivered based on the medical code lookups, wherein the medical codes may be determined by either the healthcare provider or health insurance company as well as related API feeds incorporating a patient's clinical history to support optimized segmentation.

Prescription Drug Information Overview

In various embodiments, the system is configured to enable a user (e.g., such as a doctor) to select from the one or more prescription drugs to view any of the specific, discrete portions of information that the user may desire to view. In various embodiments, the information may include particular FDA-approved statements about the prescription drug. In other embodiments, the system is configured to enable doctors and other medical professionals to obtain information about a specific drug in discreet segments in whatever time they have available and presented to the user in various formats that are intended to appeal to the individual and optimize learning, rather than sitting through a long presentation that contains substantially all of the information at one time and in a format that may not aid retention. The system provides the information to the user as a channel (e.g., a mobile website that is specifically designed for a particular drug) where the information is organized in programs (e.g., sub-links such as P.E.E.R. vs. PEER, Perspectives in Care, video library, Slide Presentation, Patient Education and Patient Assistance Program).

In particular embodiments, the system is configured to receive information about one or more prescription drugs. The information may include, for example, information in the form of video-clips, slide presentations, text, images, etc. In various embodiments, the content is information approved by a governing body for use in brand specific promotion for one or more prescription drugs (e.g., such as the FDA) to doctors, patients, or others. The system, in various embodiments, is configured to create a database for each of the one or more prescription drugs that contain discrete portions of the information about each prescription drug (e.g., side effects, ingredients, warnings, uses, overdose information, interactions, efficacy, etc.). The discrete portions of information for a particular prescription drug may include, for example, appropriate patient selection criteria, related questions and answers, adverse event profiles, a short video segment containing a presentation about uses, efficacy, and combination drug therapy and a slide show about drug interactions.

In another particular embodiment, the system is configured to receive data from a user relating to the particular prescription drug. For example, under each of the program links, the system may ask relevant questions that allow the system to collect data relating to the administration of a particular prescription drug by a doctor to a patient which may include, for example, data relating to dosage given, treatment length, efficacy of the drug, side effects experienced by the patient, etc.

In various embodiments, the system may be configured to present one or more case studies to the doctor. The case studies present the doctor with one or more questions related to the case study. In various embodiments, the one or more questions present the doctor with additional facts pertinent to the case study and then ask the doctor a specific question on how the doctor would treat the patient, what medications the doctor would use, what surgical procedures would be use if applicable, etc. Each question allows the system to gather particular information on how the user would treat the patient based on the case facts and the additional facts presented in the questions. Once the doctor answers all of the questions related to the case study and submits the answers, the system is configured to present the doctor with the doctor's answers and a comparison of each answer to the doctor's peers. The system may also be configured to present expert commentary through videos that allow the user to gain additional facts related to the drug and treatment using the drug.

Compliance Overview

In various embodiments, the system may receive standards of care, adopted medical protocols, etc. from one or more members (e.g., doctors, an administrator, practice group manager, etc.) of a particular healthcare provider group. The system may then present various case studies to the practicing doctors and gather information regarding how the doctors would treat the patients described in the case studies. In various embodiments, the system may ask a series of questions that add additional facts to the case study and request that the doctors answer the questions. The system may assemble and compare the answers to the questions to the predefined standards of care/adopted medical protocols. The system may then provide the data to one or more members of the healthcare provider group (e.g., such as an administrator) to, for example, enable the healthcare provider group to compare treatment plans taken by various members of the healthcare provider group, come up with one or more unified treatment plans for particular ailments, etc. or to help standardize care offered by the provider group.

For example, the doctors may design particular case studies that are presented to all members of the group. The case studies allow the group to solicit a treatment course for various aliments to allow the group to determine how group members are treating patients presenting with the ailments. When a group doctor clicks on one of the listed patient case studies, the doctor is presented with one or more questions on various aspects of treatment for the patient. Once the user reads the patient case study, the user may answer the one or more questions that present additional facts regarding the patient's case. Each question allows the system to gather particular information on how the user would treat the patient based on the case facts and the additional facts presented in the questions. The system may be configured to receive the doctors answers to the one or more questions and to compile the answers for the doctors in the practice. The system may then present the doctor with a comparison of the doctor's treatment plan to the treatment plans of other doctors in the practice. Moreover, the system may also present the doctor with a comparison on the doctor's treatment plan as compared to a standardized treatment plan set by the practice. The eliciting of such information allows the practice to determine if members are following standardized treatment plans, whether better treatment options are available based on the member experience or whether members of the practice are using treatment actions that may place the practice at risk for a malpractice suit.

Medical Code Overview

In various embodiments, the system is configured to receive, from one or more insurance providers, one or more codes (e.g., ICD-10 diagnosis codes and Current Procedural Terminology (CPT) codes) associated with one or more procedures performed on a particular patient, one or more diagnoses made for the particular patient, one or more treatment plans recommended to the particular patient, etc. An insurance claim made by a hospital or other healthcare provider may include, for example, information associated with particular procedures performed on, drugs administered to, and diagnoses made about a particular patient. The insurance company may then provide this information to the system. The system takes the CPT codes and determines pertinent information that may be relevant to the patient. For example, if the patent was recently diagnosed with diabetes, the system may ask the user if they would like to opt into the diabetes channel, which would provide the patient with relevant information on diabetes treatment, diabetes drugs, diabetes management (e.g., lifestyle changes, etc.). In various embodiments, the system may provide the patient with drug information for a drug that the patient was recently prescribed by their doctor. In other embodiment where the patient was recently diagnosed with cancer, the system may prompt the patient with information on support groups, treatment facilities local to the patient, etc. In still other embodiments, if the patient is prescribed one or more drugs, the system may schedule a medicine regime for the patient based on the doctors treatment plan and insert the times and dosages on an electronic calendar on the user's computer or smartphone to help the patient remember to follow the medicine regime.

### Exemplary Technical Platforms

As will be appreciated by one skilled in the relevant field, the present systems and methods may be, for example, embodied as a computer system, a method, or a computer program product. Accordingly, various embodiments may be entirely hardware or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized including, for example, hard disks, compact disks, DVDs, optical storage devices, and/or magnetic storage devices.

Various embodiments are described below with reference to block diagram and flowchart illustrations of methods, apparatuses, (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus that can direct a computer or other programmable data processing apparatus to function in a particular manner such that the instructions stored in the computer-readable memory produce an article of manufacture that is configured for implementing the functions specified in the flowchart block or blocks.

The computer instructions may execute entirely on the user's computer, partly on the user's computer, as a stand-alone software package, partly on a user's computer and partly on a remote computer, or entirely on the remote computer or server. In the latter scenario, the remote computer may be connected to the user's computer through any type of network, including but not limited to: a local area network (LAN); a wide area network (WAN); a cellular network; or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer-implemented process (e.g., method) such that the instructions that execute on the computer or other programmable apparatus provide steps for implementing the functions specified in the flowchart block or blocks.

### Example System Architecture

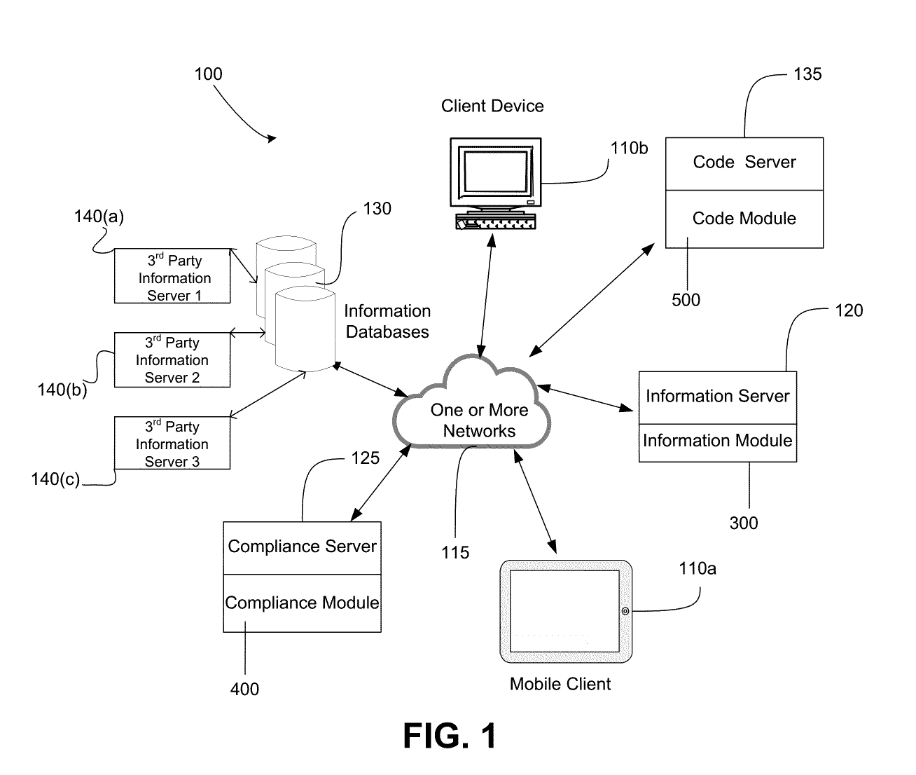

FIG. 1 is a block diagram of a Medical Information presentation system 100 according to a particular embodiments. As may be understood from this figure, the Medical Information presentation system 100 includes One or More Networks 115, One or More Computing Devices 110a, 110b (e.g., such as a smart phone, a tablet computer, a wearable computing device, a laptop computer, a desktop computer, etc.), Third-Party Information Servers 140a-140c operatively coupled to One or More Information Databases 130, an Information Server 120 including an Information module 300, a Compliance Server 125 including a Compliance Module 400, and a Code Server 135 including a Code Module 500.

The One or More Networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computing devices). The communication link between the One or More Computing Devices 110a, 110b, and the Information Server 120, Code Server 135, Compliance Server 125, Information Databases 130, and Third-Party Information Servers 140a-140c may be, for example, implemented via a Local Area Network (LAN) or via the Internet.

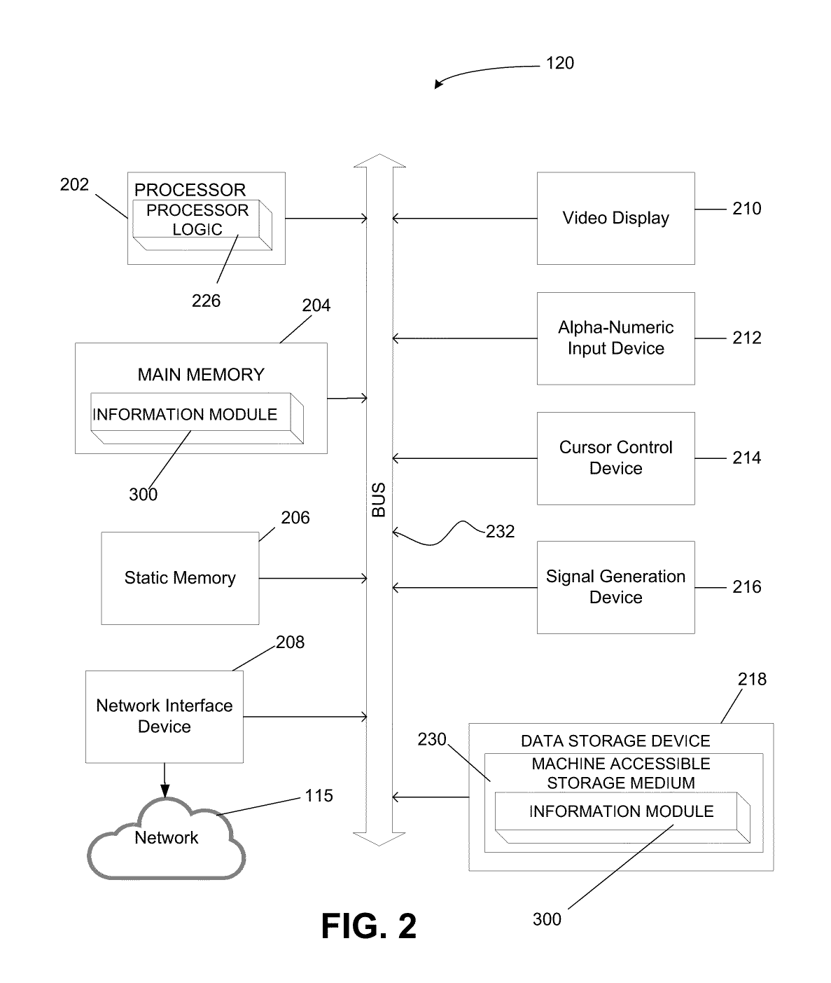

FIG. 2 illustrates a diagrammatic representation of the architecture for the Information Server 120 that may be used within the Medical Information presentation system 100. It should be understood that the computer architecture shown in FIG. 2 may also represent the computer architecture for any one of the One or More Computing Devices 110a, 110b, Compliance Server 125, Code Server 135, Information Server 120, or the One or More 3^{rd} Party Information Servers 140a, 140b, 140c shown in FIG. 1. In particular embodiments, the Information Server 120 may be suitable for use as a computer within the context of the Medical Information Presentation system 100 that is configured for receiving information associated with a prescription drug, dividing the information into one or more subgroups of information, associating a link with each respective subgroup of information, associating a plurality of questions with each subgroup of information, and presenting each link to a user. The presentation of the information may be configured to be presented over a handheld device, enabling a user to view one of the subgroups of information and to view and answer the respective plurality of questions. The answers received to the plurality of questions, which of the subgroups of information the user viewed, and the time spent by the user in the presented one or more subgroups of information may be tracked and stored locally by the user or locally until the occurrence of some condition (e.g. connection to a wireless network, authorization by the user to submit over a 3G/4G/LTE network, etc.), or may be tracked and stored on the Information Server 120.

In particular embodiments, the Information Server 120 may be connected (e.g., networked) to other computing devices in a LAN, an intranet, an extranet, and/or the Internet as shown in FIG. 1. It should be understood that the architecture of the Information Server 120 is substantially similar to (i.e. the same as), the architecture of the Code Server 135 and the Compliance Server 125. As noted above, the Information Server 120 may operate in the capacity of a server or a client computing device in a client-server network environment, or as a peer computing device in a peer-to-peer (or distributed) network environment. The Information Server 120 may be a desktop personal computing device (PC), a tablet PC, a set-top box (STB), a Personal Digital Assistant (PDA), a cellular telephone, a web appliance, a network router, a switch or bridge, or any other computing device capable of executing a set of instructions (sequential or otherwise) that specify actions to be taken by that computing device. Further, while only a single computing device is illustrated, the term “computing device” shall also be interpreted to include any collection of computing devices that individually or jointly execute a set (or multiple sets) of instructions to perform any one or more of the methodologies discussed herein.

An exemplary Information Server 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose or specific processing devices such as a microprocessor, a central processing unit (CPU), or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The Information Server 120 may further include a network interface device 208. The Information Server 120 may also include a video display unit 210 (e.g., a liquid crystal display (LCD) or a cathode ray tube (CRT)), an alpha-numeric input device 212 (e.g., a keyboard), a cursor control device 214 (e.g., a mouse), and a signal generation device 216 (e.g., a speaker).

The data storage device 218 may include a non-transitory computing device-accessible storage medium 230 (also known as a non-transitory computing device-readable storage medium or a non-transitory computing device-readable medium) on which is stored one or more sets of instructions (e.g., the Information Module 300, the Compliance Module 400, and the Code Module 500) embodying any one or more of the methodologies or functions described herein. The one or more sets of instructions may also reside, completely or at least partially, within the main memory 204 and/or within the processing device 202 during execution thereof by the Information Server 120—the main memory 204 and the processing device 202 also constituting computing device-accessible storage media. The one or more sets of instructions may further be transmitted or received over a network 115 via a network interface device 208.

While the computing device-accessible storage medium 230 is shown in an exemplary embodiment to be a single medium, the term “computing device-accessible storage medium” should be understood to include a single medium or multiple media (e.g., a centralized or distributed database, and/or associated caches and servers) that store the one or more sets of instructions. The term “computing device-accessible storage medium” should also be understood to include any medium that is capable of storing, encoding, or carrying a set of instructions for execution by the computing device and that causes the computing device to include any one or more of the methodologies of the present invention. The term “computing device-accessible storage medium” should accordingly be understood to include, but not be limited to, solid-state memories, optical and magnetic media, etc.

### Exemplary System Platform

Various embodiments of a computer-implemented method of presenting discrete prescription drug information to a medical professional over a handheld device are described below and may be implemented in any suitable context. For example, particular embodiments may be implemented within the context of a medical education class that is intended to provide information about a condition and the treatment context. In still other embodiments, the system may also be integrated into other systems, for example, a hospital, practice group, or private clinics' existing pharmaceutical information library.

Various aspects of the system's functionality may be executed by certain system modules, including the Information Module 300. The Information Module 300 is discussed in greater detail below.

Information Server Module

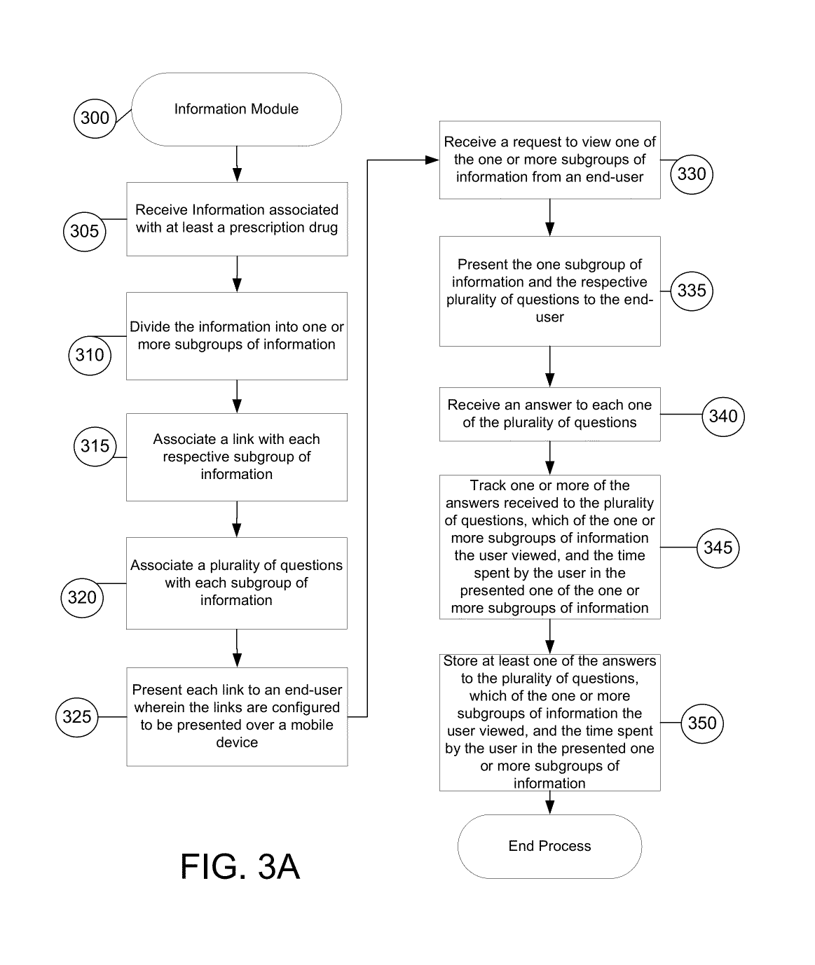

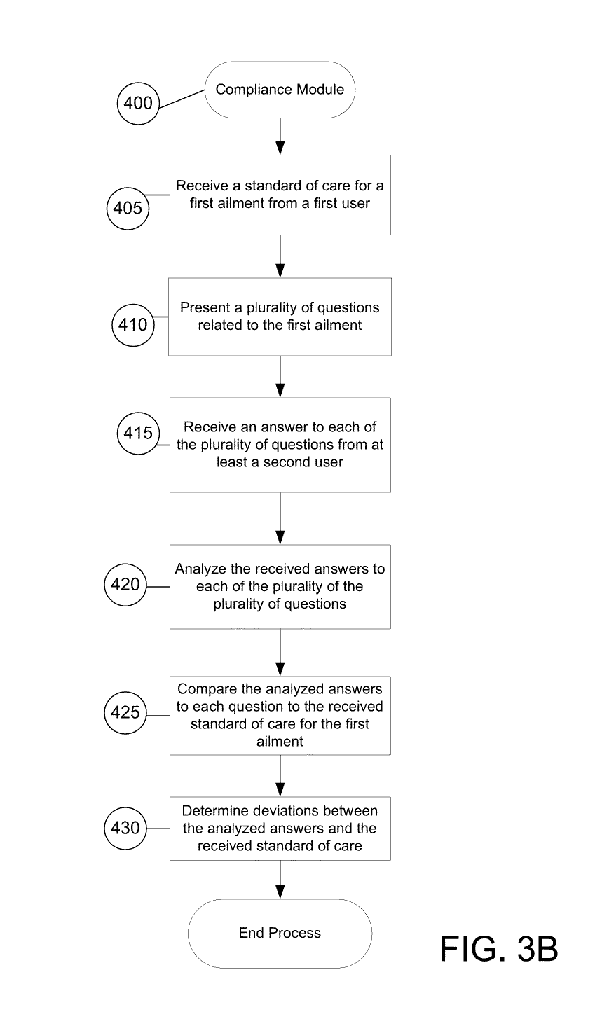

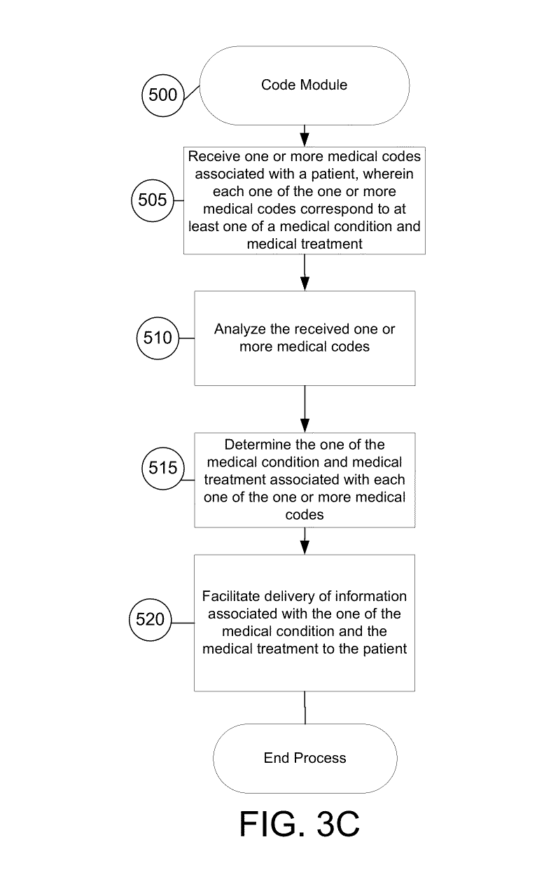

Referring to FIG. 3A, when executing the Information Module 300, the system begins, in various embodiments, at Step 305 by receiving information associated with at least a one prescription drug. The system receives, for example, information regarding a drug name, drug classification, chemical formulations, dosage and administration, precautions, adverse reactions, side effects, overdose information, contraindications, clinical pharmacology, and instructions for use. The system may also receive information from non-publicly available sources, such as 3^{rd} party clinical research papers, conference presentations by experts in the field, marketing materials, or proprietary medical practitioner feedback, as will be discussed further below.

At Step 310, the system divides the received information into one or more subgroups of information. In various embodiments the system divides the information into one or more subgroups automatically by prescription drug subtopics, as discussed herein. In various other embodiments, the information may be subdivided manually to better adapt the information for a particular use, for example, for use as a pharmaceutical drug sales aid. In particular embodiments, the divided information may be information that is used to promote the drug to doctors and other health care prescribers. For example, the subgroups of information may be divided into one or more case studies regarding patients that can be treated with the prescription drug. In particular embodiments, the one or more subgroups may consist of: (1) side effect information for the prescription drug; (2) one or more uses for the prescription drug; (3) one or more ingredients in the prescription drug; (4) efficacy information for the prescription drug; (5) one or more warnings associated with the prescription drug; (6) case studies that are associated with using the prescription drug in a treatment plan; (7) videos containing information presented by clinical experts on patients and diseases related to the prescription drug; and (8) questions that allow the system to collect user data related to the prescription drug.

Continuing at Step 315, the system associates a unique link with each respective subgroup of information. The system may then present the user with one or more subgroups of information regarding a particular prescription drug of interest, wherein each of the one or more subgroups of information each have a respective link associated with the subgroup of information. The information is presented to the user, in various embodiments, as a discrete parcel of information, in which the user can learn about a specific area of interest. The link may open a webpage, or may display the requested information within an application on a mobile device. The link may, for example, be provided to the user via SMS or as a hyperlink within an email.

Continuing at Step 320, the system associates a plurality of questions with each respective subgroup of information. In particular embodiments, the plurality of questions may include one or more questions directed to one or more topics, including: (1) the prescribed dosage; (2) the treatment length; (3) the efficacy of the prescription drug experienced by the user; (4) the side effects of the prescription drug detected by the user; (5) other drugs prescribed by the user concurrently with the prescription drug; (6) information about the disease or disorder being treated with the prescription drug; (7) results the user expects to achieve from treatment with the prescription drug; (8) characteristics of the patient being prescribed the prescription drug; and (9) lab results related to the patient prescribed the prescription drug.

In various other embodiments, the plurality of questions associated with each respective subgroup of information may relate to a case study regarding treatment of a patient. Additionally, in certain embodiments, the questions relating to the case study of a patient may add additional facts to the fact pattern of the case study. In yet other embodiments, the user's answers to the various questions presented may dynamically adapt the order of the questions, the questions presented, or subject matter presented in the remaining questions.

Continuing at Step 325, the system presents each link to an end-user over a mobile device. In various embodiments, the mobile device may be, for example, a laptop computer, a smartphone, a tablet, etc. The presented links may be formatted to link to information presented to the user in a web browser, or may be formatted to present the requested information within an application. In particular embodiments, the web links may be organized as a channel for each pharmaceutical drug and the channel may be subdivided with sub links to link a program under the channel to the proper subject matter. In various other embodiments the information about the drug is organized into the several programs that the doctor can choose from in order to receive, read or watch small amounts of pertinent information. In various other embodiments, the information may be provided by a mobile application, wherein the information is subdivided into topics and subtopics.

Continuing at Step 330, the system receives a request from an end-user to view one of the one or more subgroups of information. The request to view a subgroup of information may be in response to a user-initiated request through a menu (e.g. drop-down menu). The request may also be made by a user following a text message link to open the website or application. In various embodiments, the doctor may send a text of the name of a drug to a particular number using their mobile phone. The system returns a text containing a website link for the particular drug. When the doctor clicks on the link in the text, the system takes them to a login page where the doctor can enter their credentials. Once logged into the system, the system directs the user to a branded site (Channel) that contains the information specific for the drug. The user may then select one of the one or more links associated with the various subgroups of information, which in turn sends a request to the system to present the information associated with the selected link.

Continuing at Step 335, at least partially in response to receiving the request to view one of the one or more subgroups of information, the system presents the subgroup of information and the respective plurality of questions to the end user. In various embodiments, the system presents the subgroup of information selected from a group consisting of: (1) a slide presentation; (2) a video library; (3) case studies; (4) patient education; and (5) patient assistance information.

In various other embodiments, the one or more subgroups of information may also consist of one or more case studies regarding patients presenting with conditions that may be treated with the particular prescription drug, and a plurality of questions directed to methods of treatment using the prescription drug. Furthermore, the presented respective plurality of questions, in various embodiments, are directed to one or more topics selected from a group consisting of: (1) the prescribed dosage; (2) the treatment length; (3) the efficacy of the prescription drug experienced by the user; (4) the side effects of the prescription drug detected by the user; (5) other drugs prescribed by the user concurrently with the prescription drug; (6) information about the disease being treated with the prescription drug; (7) results the user expects to achieve from treatment with the prescription drug; (8) characteristics of the patient being prescribed the prescription drug; (9) lab results related to the patient prescribed the prescription drug, or (10) any other subject matter associated with the presented case, drug treatment options or one or medical treatments.

Continuing at Step 340, the system receives an answer to each one of the plurality of questions. The answers may be received as one of (1) several multiple-choice answers to a question, (2) as a true/false answer or (3) through textual answers, which are automatically analyzed by the system by a natural language program and analyzed for context. Users may additionally be directed to skip questions where appropriate. The received answers may be submitted all at one time once the user provides an answer to each one of the one or more questions. In other various embodiments, the answers may also be received one at a time, such that the subsequently presented questions are dynamically selected and arranged based on the user's responses to prior questions. For example, in an embodiment where the user's answers are submitted to the system all at once, the questions presented to the user are selected at the beginning of the presentation and are static. In contrast, for questions that are analyzed when the answer is submitted by the user, the system may present the questions that follow based on the user's response and change dynamically based on the answers given by the user. This may occur, for example, when a user submits an incorrect response and the system presents a question directed to the same topic as the question for which that incorrect response was submitted to further inform the user on the topic.

Continuing at Step 345, the system tracks: (1) one or more of the answers received to the plurality of questions; (2) which of the one or more subgroups of information the user viewed; and (3) the time spent by the user in the presented one of the one or more subgroups of information. In various embodiments, the system tracks this information for at least analytical purposes. The analytics that may be developed can be utilized to determine if the presentation of information on the topic is meeting the expected results, based on the answers to the questions. Additionally, the analyzed data may be utilized to revise the materials, in order to improve comprehension and the likelihood that the user would prescribe the subject prescription medication.

In various other embodiments, the system may track the answers given to a particular question and compare it to the time spent within the associated subgroup of information. The system tracks this correlation to more easily ascertain whether incorrect answers given to some questions reflect a lack of time spent in the materials or an unexplained significant deviation from the practices and treatment procedures of one's peers. In still other embodiments, tracking the answers given, subgroup(s) of information viewed, and time spent by the user in the presented subgroup(s) allows a pharmaceutical company to independently view the engagement of the audience with regard to a particular pharmaceutical drug or practice area.

Continuing at Step 350, the system stores: at least one of (1) the answers to the plurality of questions; (2) which of the one or more subgroups of information the user viewed; and (3) the time spent by the user in viewing the presented subgroups of information in memory. In various embodiments, the information may be stored locally on the user's device so that the user's progress in discrete subgroups may be tracked for their own personal use. In other various embodiments, the system stores the aforementioned information remotely such that the aggregation of data from multiple users may be compiled and analyzed for global trends across the system.

In various embodiments, the data collected by the system may be used to enhance the information presented to the users, as discussed above. It should be understood from reference to this disclosure that users' answers to presented questions may be used to help the user compare their knowledge to other users, increase the user's knowledge about available treatments using the prescription drug, or to allow the manufacturer of the prescription drug to enhance or change the information and method of presenting the information to the user.

In other embodiments, the user may also request additional information from the system when the user is answering the one or more questions associated with any one of the subgroups of presented information. For example, if a user (1) answers one or more questions incorrectly; (2) lacks the knowledge to attempt to answer the question; or (3) would like to learn more about the subject matter of a question, the user may request a more thorough overview of the particular subgroup of information associated with the questions. Moreover, the user, upon being presented a question related to a particular pharmaceutical drug, treatment option, or medical condition may request more information related to one of the aforementioned topics. In yet other embodiments, the user may be presented with additional supportive information in response to the answers submitted to the system for the presented questions. For example, upon answering a subset of questions regarding a subgroup of information, the user may receive a result that indicates a significant disparity between their answers and the answers of their peer group. In order to better determine the clinical appropriateness of the user's responses, the user may receive information regarding currently acceptable treatment methods, which may include the most commonly received response as well as the user's response to the plurality of questions.

### Compliance Module

Referring to FIG. 3B, when executing the Compliance Module 400, the system begins, in various embodiments, at Step 405 by receiving a standard of care for a first ailment from a first user. In various embodiments, the standard of care received by the system may be defined on a national, state, regional, or intra-practice group level. For example, standards may be established by a medical administrative body, e.g. state or national boards, a physicians' organization such as the American Medical Association or Mayo Clinic, or may be defined by the members of the group to which the user belongs, for example, within a practice group, a hospital administrative group, etc. In various other embodiments, the standard of care may further consist of one or more procedures or drug protocols for treating the ailment. For example, at least a portion of the defined standard of care may consist of a practice group or medical administrative body's established diagnostic procedures for identifying and treating a specific disease/disorder.

Continuing at Step 410, the system presents a plurality of questions related to the first ailment. In various embodiments, the presented plurality of questions related to the ailment may pertain to the: (1) cause of an ailment; (2) symptoms; (3) disease progression; (4) risk factors; (5) time to seek medical attention; (6) exams, tests and/or test results; (7) treatment overview; (8) prevention; (9) home treatment; (10) medications; (11) alternative treatments; and (12) other related or contributory factors. In other various embodiments, the plurality of questions may relate to a case study. For example, a user may view a case study in which a patient presents with a given set of symptoms and the user is asked which treatment option he/she would use to treat the patient. In various embodiments, the system presents one or more case studies that contain one or more questions associated with each respective case study. Each of the case studies describes a patient having one or more symptoms. The one or more questions associated with the case study provide additional information that allows the user to diagnose and treat the underlying disease presented by the patient. The user may then select a prescription medication alone, or in combination with various tests, procedures, and other medications as part of a treatment course. In various embodiments the questions may be static based on the subject matter selected by the user. In various other embodiments, the questions are dynamically chosen based on a user's answer to a previously presented and answered question.

Continuing at Step 415, the system receives an answer to each of the plurality of questions from at least a second user. In various embodiments, the system may receive answers from one or more doctors in a practice group, one or more doctors in a hospital, one or more hospital administrators, or one or more regulatory bodies, etc. The received answers may include an option to skip a question without providing an answer, for example, when the question asks the second user's preferred treatment method for a condition with which the second user may not be familiar.

Continuing at Step 420, the system analyzes the received answers to each of the plurality of questions. In various embodiments, the system may analyze the responses by identifying trends. The system may additionally generate a report that illustrates deviations between various users' answers and the standard of care for the first ailment received in step 405. Additionally, such an analysis may further distinguish the received answers by a user's geographical location, years of experience, specialty, or any variety of factors particular to the user. The answers to the one or more questions that relate to alternative treatment options may further be grouped with other answers to questions related to alternative treatments.

Continuing to Step 425, the system compares the analyzed answer to each question, to the received standard of care for the first ailment. A report may be generated based on the grouping of answers for each particular question, relating to, for example, the treatment of the first ailment based on the answers from other users. This report may be, in various embodiments, provided to the user such that the user may compare their answers with the answers given by others, or may be provided to the user such that the user may compare their answers to the standard of care provided by the first user.

Continuing to Step 430, the system determines deviation between the analyzed answers and the received standard of care. In various embodiments, the deviations may be illustrated in a report comparing the second users' answers to the standard of care/treatment protocols provided by the first user. These deviations, in particular embodiments, may also include alternative treatments for a particular disease. Deviations between the standard of care and the analyzed answers may also take into account differing standards of care across various locales or practice groups. For example, the standard of care within one region may significantly differ from the standard of care in another region based on the resources of the facility. Therefore, the appropriateness of a user's response will vary depending on the standard of care utilized in the analysis. In various embodiments, the deviations may be summarized in a report for use by the administrators of a practice group or hospital in educating members of the practice on the proper standards of care or adopted treatment protocol. In other embodiments, the deviations may be used to improve adopted standards of care to encompass improved methods, drugs and procedures.

### Code Module

Referring to FIG. 3C, when executing the Code Module 500, the system begins, in various embodiments, at Step 505, by receiving medical codes. In various embodiments, the system is configured to receive one or more medical codes associated with a patient. Each one of the one or more medical codes corresponds to at least one of a medical condition and medical treatment. These medical codes may be, for example, diagnostic codes, procedural codes, pharmaceutical codes, topographical codes, or other standardized coding types. Commonly utilized medical diagnostic codes include the International Statistical Classification of Diseases and Related Health Problems (ICD) and its national variants, the Diagnostic and Statistical Manual of Mental Disorders (DSM), procedures, and the Systemized Nomenclature of Medicine (SMOMED). In various embodiments, the one or more medical codes arise when a doctor submits an insurance reimbursement request to a payer (e.g., an insurance company, insurance plan administrator, etc.). The system may receive the one or more medical codes directly from a doctor's office or the system may receive the one or more medical codes from the payer.

Continuing to Step 510, the system analyzes the received one or more medical codes. In various embodiments, the system uses the medical code received in Step 505 and determines at least one of: (1) the classification type; (2) the procedure performed; (3) the medication prescribed; (4) the area of the body that contains the system affected; (5) the diagnosis; and (6) other coded indications. In various embodiments, the analysis may consist of identifying which standardized coding system is being utilized, finding the corresponding information regarding the code, determining other associated codes that relate to one another, and determining an ailment, diagnosis, treatment or drug associated with the codes.

Continuing to Step 515, the system determines at least one of the medical condition and medical treatment associated with each one of the one or more medical codes. Upon determining the proper coding system utilized in Step 510, the system determines at least one of the medical condition and treatment associated with each of the one or more medical codes by cross-reference to the corresponding version of the standardized coding system. In various embodiments, the system must take into account multiple related codes all corresponding to a single disease diagnosis and keep these differing codes associated. For example, typical treatment of certain diseases/disorders requires multiple pharmaceutical treatments, and often a combination of pharmaceutical and physical therapy. By keeping the related codes associated together with a single disorder, the system is able to minimize the possibility of a misdiagnosis and provides a more complete portrayal of the disorder and treatment course prescribed by a physician.

Continuing to Step 520, the system facilitates the delivery of information associated with the one of the medical condition and the medical treatment to the patient. In various embodiments, the system may provide information associated with one or more procedures, one or more diagnoses, one or more treatment plans, etc. to the particular patient via text message, email hyperlink, or any other suitable means of communication with the patient. For example, when a patient registers with the system, the patient may receive a text or e-mail requesting that the patient opt into a channel that is related to the one or more procedures, one or more diagnoses, one or more treatment plans associated with the patient. That is, if the patient was recently diagnosed with diabetes, the system receives the diagnosis codes from the patient's doctor or insurer and invites the patient to opt into a diabetes channel that provides the patient with disease information, lifestyle changes that would be beneficial in treating the disease and other disease or treatment related information. The information may include, for example, dietary recommendations based on a particular diagnosis, a recovery plan for a particular procedure (e.g., rest, limitations on particular activities, etc.), administration instructions for a particular prescribed medication (e.g., take twice daily, take with food, do no operate machinery, etc.), etc.

In some particular embodiments, the system may be configured to provide reminders to the patient to take a prescribed medication, attend a support group, remind the patient of a scheduled appointment, and integrate appointments into the electronic calendar on the patient's handheld device etc. In other embodiments, the information provided to the particular patient may include any suitable information that may be useful to the particular patient relating to the patient's diagnosis and/or treatment. For example, the system may inquire whether the user would like information on support groups related to the patient's diagnosis. If the patient responds affirmatively, the system may provide the user with one or more local support groups and information related to each listed support group.

In other particular embodiments, the system presents a survey to a user with regard to the user's current health, lifestyle, life events, and other demographic information (e.g., name, age, weight, BMI, etc.). The system may also find and incorporate data from multiple other related sources, such as a physician or healthcare facility's electronic health records. These survey questions and demographic information constitute at least part of the epidemiological information that may be utilized by the system to identify health trends, such as identifying patients that are at a high risk of developing various health related conditions, or other factors that may contribute to or exacerbate various health conditions.

If the system identifies a potential health concern based on the survey responses, health information, or epidemiological information, the system may send to the user via, for example, SMS, email, website/application messaging system, further questions related to the identified potential health concern. For example, data exists that suggests there is a higher than average incidence of obesity among truck drivers and hair stylists, as compared to various other professions. Additionally, there are various health conditions, for example, diabetes, arthritis, Prader-Willi syndrome, and Cushing's syndrome that can sometimes be linked to obesity. Various risk factors, such as family lifestyle, level of inactivity, unhealthy diet and eating habits, pregnancy, and even quitting smoking are also often associated with weight gain and possible obesity. If the system receives information from the user or prior health records indicating the existence of a health condition or lifestyle choice that is related to various health disorders, the system will seek further data on the user to segment the user into the proper health category.

As the user ages, the system monitors the various health records and seek additional data related to health conditions or life events, such as specific age related conditions, gender related conditions, or post-divorce etc. Various life events, such as divorce, having a child, age-related illnesses, and other factors have shown a correlation to various health related conditions and an increased risk of developing various health related conditions. By tracking and re-engaging the user based on updated or newly available information, the system may better segment and proactively research and validate trends between life events, various segments, and correlated health conditions. Further, actively identifying trends may additionally aid engagement, retention, and the outcome of treatments for the identified health conditions.

### User Experience

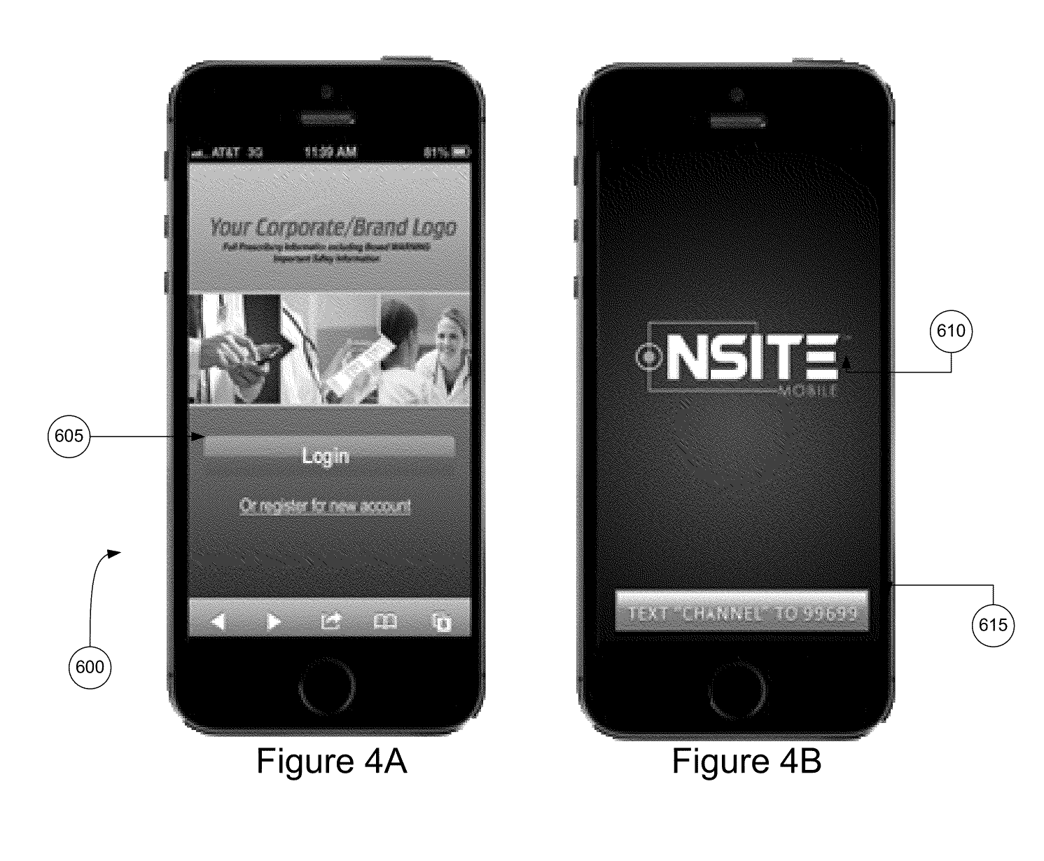

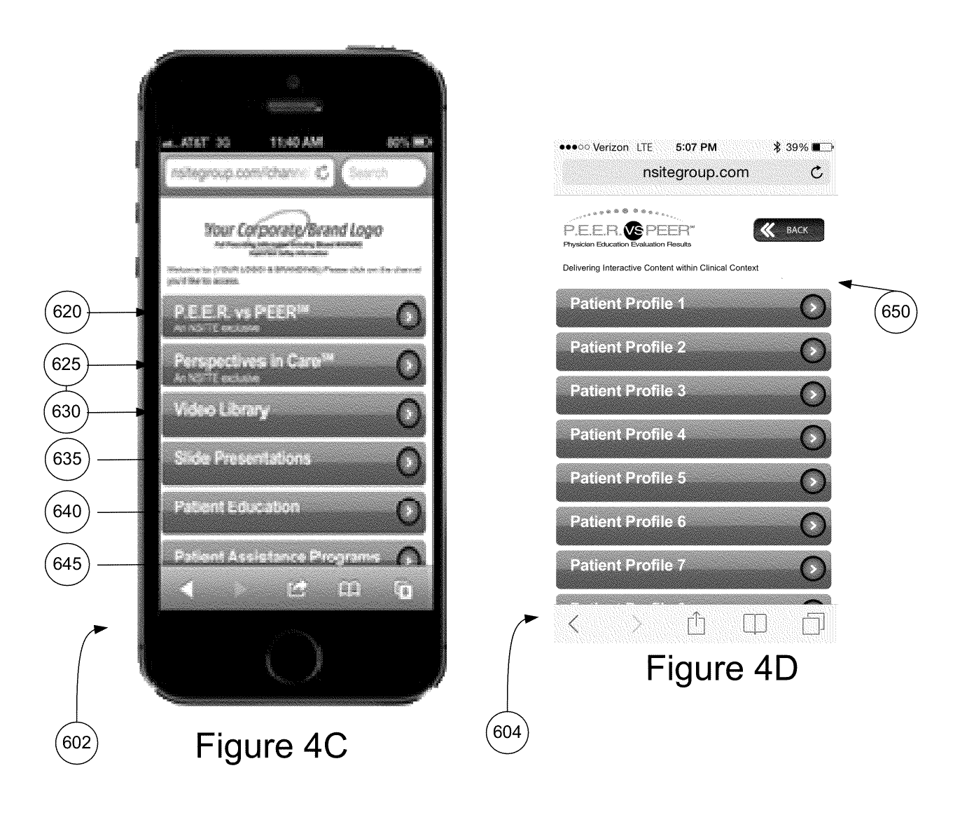

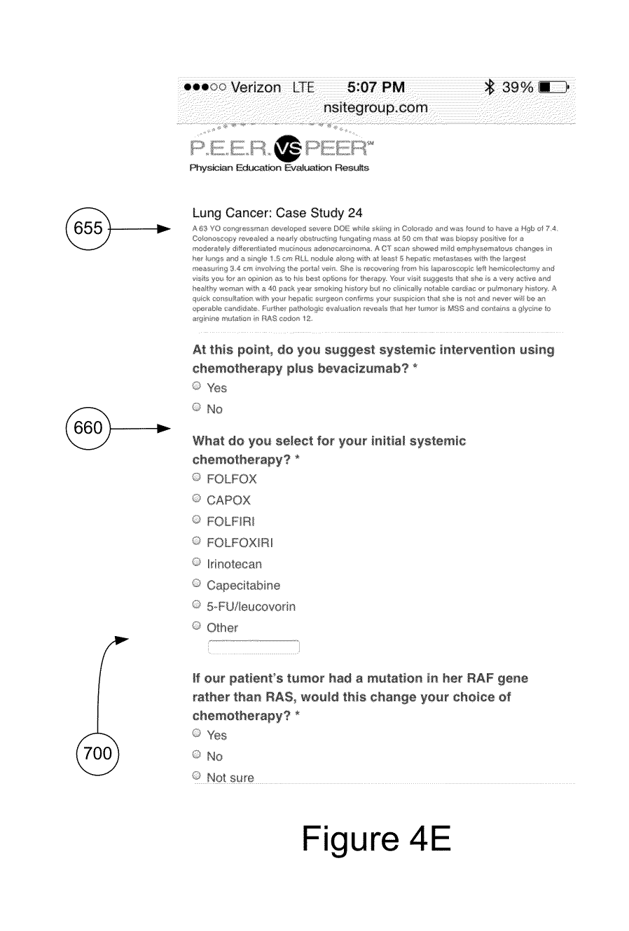

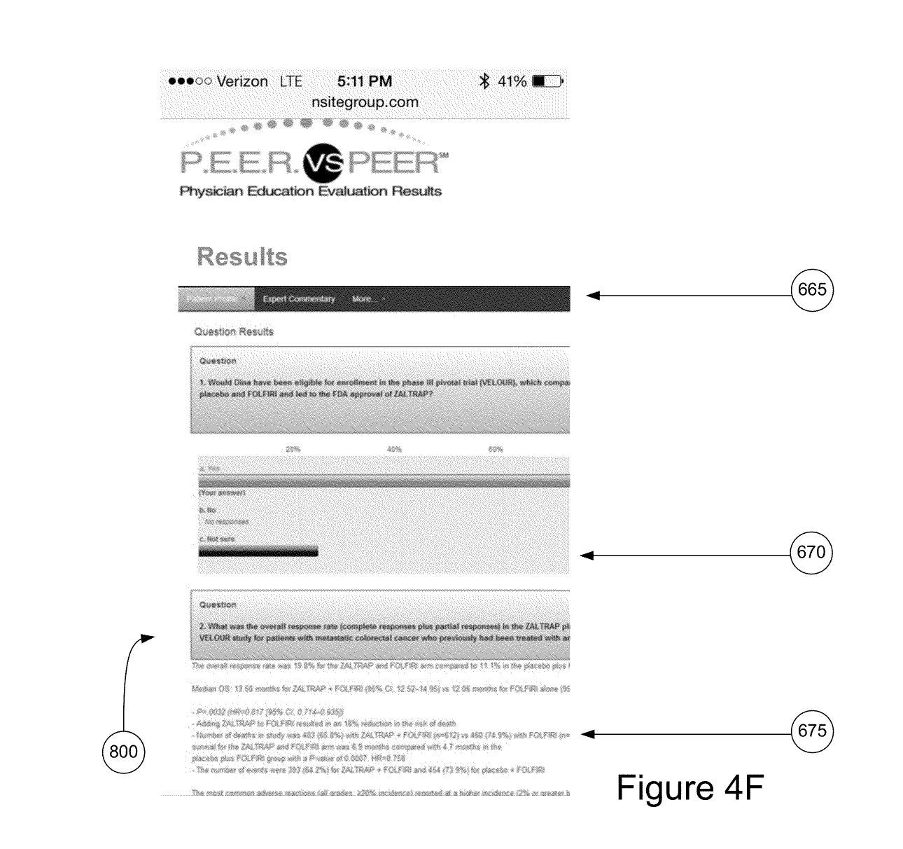

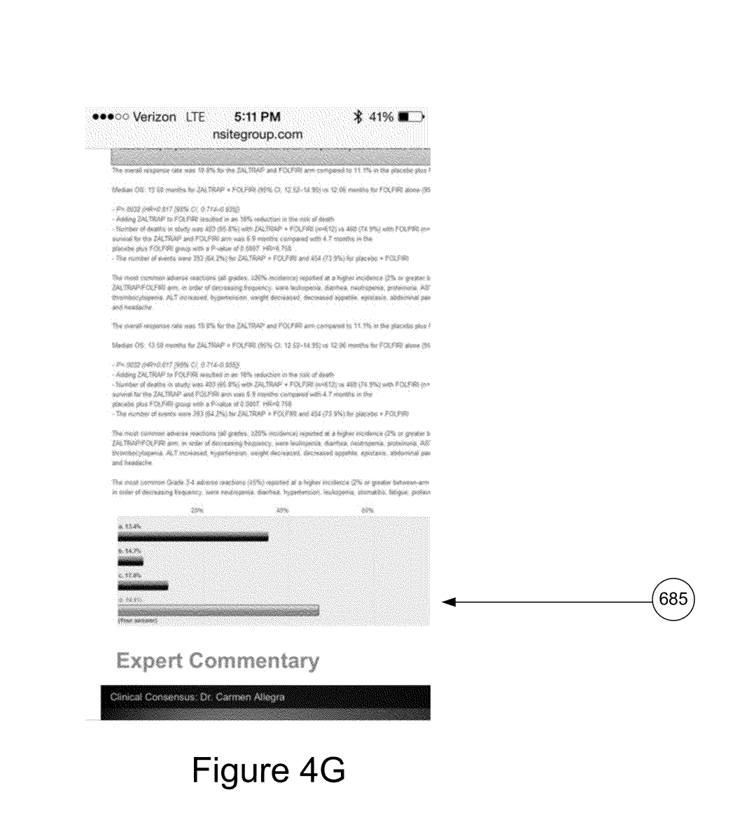

FIGS. 4A-4G depict exemplary screen displays which a user may experience when using the system. FIGS. 4A-4B depicts two user interfaces that illustrate two example methods for the user to access discrete segments of information. FIG. 4A depicts the user application or website interface 600 that allows the user to login to the mobile site using a login link 605 in order to access the desired information. FIG. 4B depicts the mobile text message system 610 that allows a user to enter the site by sending a text message to the system. As may be further understood from the above disclosure and the figure, a user can text, for example, “channel” name, disorder type, or a pharmaceutical drug name to a designated number 615, and receive a reply text message containing a link to the requested information.

FIG. 4C depicts an exemplary screen display 602, of the information menu options as discussed in the above disclosure. As may be further understood from this figure, the user may access the following sub-menus: P.E.E.R. vs PEER sub menu 620, Perspectives in Care sub menu 625, Video Library sub menu 630, Slide Presentation sub menu 635, Patient Education sub menu 640, and Patient Assistance Programs sub menu 645, among other features not shown. These sub-menus allow for the presentation of requested discrete information regarding a pharmaceutical in the requested format.

FIG. 4D depicts an exemplary screen display 604 of the patient profile case study 650 that may be accessed from the information menu options 602. As may be further understood from this figure, the screen display 604 allows for the user to access case studies related to the pharmaceutical or disease/disorder area they are interested in exploring.

FIG. 4E depicts an exemplary screen display 700, of a P.E.E.R. vs PEER case study and corresponding question set. As may be further understood from this figure, the user is presented with a case study 655 that relates to the requested disease or pharmaceutical treatment they have requested. The user is directed to carefully review the background information, and is then asked a series of questions 660 related to the case study and treatment options. As may be further understood from the above disclosure, the answers to the questions and case study prompts may be used for comparing standard of care practices within and across geographical locations, practice groups, and hospitals or the questions may be used to obtain information from the user when the user is reviewing information for a particular drug.

FIGS. 4F-4G depicts an exemplary screen display 800, of the P.E.E.R. vs Peer result analysis. As may be further understood from this figure, after the user completes the related questions 660, their responses are analyzed, as shown at 665, and compared to others who have answered the same questions or as compared to a pre-defined standard of care in 670. As discussed above, the user may compare their answers with others in a particular region, state, country, practice group, or other discipline or may compare their answers with a pre-defined standard of care, which is generally the most universally adopted option for treatment. In various other embodiments, the user may also compare their answers with generally accepted alternative treatments. Additionally, the user may also offer feedback or a more thorough written explanation to one or more of the questions and answers, 675, as well as review feedback from other users that may discuss the techniques, dosage, administration, side effects, or other pharmacological aspects of treatment more thoroughly through the expert commentary functionality 685 (FIG. 4G).

### CONCLUSION

Many modifications and other embodiments of the invention will come to mind to one skilled in the art to which this invention pertains, having the benefit of the teaching presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed:

1. A computer-implemented method of presenting discrete prescription drug information to a medical professional over a handheld device, the method comprising:
a. receiving, by a processor, information associated with a prescription drug;
b. dividing, by a processor, the information into one or more subgroups of information;
c. associating, by a processor, a link with each respective subgroup of information;
d. associating, by a processor, a plurality of questions with each subgroup of information;
e. presenting, by a processor, each link to a user, wherein the links are configured to be presented over a handheld device;
f. receiving, by a processor, from a user a request to view one of the one or more subgroups of information;
g. at least partially in response to receiving the request, presenting, by a processor, the one of the one or more subgroups of information and the respective plurality of questions to the user;
h. receiving, by the processor, an answer to each one of the plurality of questions;
i. tracking, by a processor, one or more of the answers received to the plurality of questions, which of the one or more subgroups of information the user viewed, and the time spent by the user in the presented one of the one or more subgroups of information; and
j. storing, by a processor, at least one of the answers to the plurality of questions, which of the one or more subgroups of information the user viewed, and the time spent by the user in the presented one of the one or more subgroups of information.

2. The computer-implemented method of claim 1, wherein the one or more subgroups of information are selected from a group consisting of:
a. a slide presentation;
b. a video library;
c. case studies;
d. patient education; and
e. patient assistance information.

3. The computer-implemented method of claim 2, wherein the one or more subgroups of information further comprises:
a. one or more case studies regarding patients that can be treated with the prescription drug; and
b. the plurality of questions are directed to methods of treatment using the prescription drug.

4. The computer-implemented method of claim 1, wherein the plurality of questions include one or more questions directed to one or more topics selected from a group consisting of:
a. the prescribed dosage;
b. the treatment length;
c. the efficacy of the prescription drug experienced by the user;
d. side effects of the prescription drug detected by the user;
e. other drugs prescribed by the user concurrently with the prescription drug;
f. information about the disease being treated with the prescription drug;
g. results the user expects to achieve from treatment with the prescription drug;
h. characteristics of the patient being prescribed the prescription drug; and
i. lab results related to the patient prescribed the prescription drug.

5. The computer-implemented method of claim 1, wherein the one of the one or more subgroups of information associated with the prescription drug comprise information selected from a group consisting of:
a. side effect information for the prescription drug;
b. one or more uses for the prescription drug;
c. one or more ingredients in the prescription drug;
d. efficacy information for the prescription drug;
e. one or more warning associated with the prescription drug;
f. case studies that are associated with using the prescription drug in a treatment plan;
g. videos containing information presented by clinical experts on patients and diseases related to the prescription drug; and
h. questions that allow the system to collect user data related to the prescription drug.

6. The computer-implemented method of claim 1, further comprising after the user answers each of the plurality of questions, presenting, by a processor, a comparison of the user's answers to each question to the answers of other users.

7. The computer-implemented method of claim 1, wherein the user's answers to the plurality of questions are used to modify the subgroup of information associated with the plurality of questions.

8. A computer-implemented method of ensuring compliance with standards of treatment among healthcare providers, the method comprising:
a. receiving, by a processor, from a first user a standard of care for a first ailment;
b. presenting, by a processor, a plurality of questions that relate to the first ailment;
c. receiving, by a processor, an answer to each of the plurality of questions from at least a second user;
d. analyzing, by a processor, the received answers to each respective question of the plurality of questions;
e. comparing, by a processor, the analyzed answers to each question to the received standard of care for the first ailment; and
f. determining, by a processor, differences between the analyzed answers and the received standard of care.

9. The computer-implemented method of claim 8, further comprising generating, by a processor, a report that illustrates the differences.

10. The computer-implemented method of claim 8, wherein the standard of care further comprises one or more procedures for treating the first ailment.

11. The computer-implemented method of claim 10, wherein the step of presenting a plurality of questions that relate to the first ailment further comprises:
a. presenting, by a processor, a case study that relates to the first ailment; and
b. presenting, by a processor, one or more questions that relate to the treatment of the first ailment.

12. The computer-implemented method of claim 11, wherein the step of presenting a plurality of questions that relate to the first ailment further comprises presenting, by a processor, one or more questions that relate to alternative treatment of the first ailment.

13. The computer-implemented method of claim 12, further comprising the steps of:
a. analyzing, by a processor, answers to the one or more questions that relate to the alternative treatment;
b. grouping, by a processor, answers for each particular question of the one or more questions that relate to the alternative treatment; and
c. facilitate, by a processor, the generation of at least one report based on the grouping of the answers for each particular question.

14. The computer-implemented method of claim 11, further comprising the steps of:
a. receiving, by a processor, answers to each one of the one or more questions that relate to treatment of the first ailment from a second user;
b. comparing, by a processor, the answers to each one of the one or more questions that relate to treatment of the first ailment to answers from other users;
c. generate, by a processor, a report based on the comparison of the second user's answers to the other user's answers; and
d. provide, by a processor, access to the generated report to the second user.

15. A computer-implemented method of providing information to a user comprising:
a. receiving, by a processor, one or more medical codes associated with a patient, wherein each one of the one or more medical codes correspond to at least one of a medical condition and medical treatment;
b. analyzing, by a processor, the received one or more medical codes;
c. determining, by a processor, the one of the medical condition and medical treatment associated with each one of the one or medical codes;
d. facilitate, by a processor, delivery of information associated with the one of the medical condition and the medical treatment to the patient.

16. The computer-implemented method of claim 15, wherein the one or more medical codes are received from one of an insurance payer and a medical provider.

17. The computer-implemented method of claim 15, wherein the information delivered is chosen from a group consisting of:
a. treatment options;
b. medicines available for the medical condition;
c. lifestyle changes to cope with the medical condition;
d. information about support groups in the area;
e. drug information;
f. reminder notices to take a prescribed drug associated with the medical treatment;
g. appointment reminders associated with the medical treatment;
h. treatment information;
i. self-help information; and
j. medical provider information.

18. The computer-implemented method of claim 15, further comprising delivering, by a processor, the information associated with the one of the medical condition and the medical treatment to the patient via a handheld cellular device.

19. The computer-implemented method of claim 17, wherein the reminder notices are integrated into an electronic calendar on the patient's handheld device.

20. The computer-implemented method of claim 15, further comprising displaying, by a processor, the information associated with the one of the medical condition and the medical treatment to the patient via a handheld device.
